(19) United States
(12) Patent Application Publication
(10) Pub. No.: US 2012/0106166 A1
(43) Pub. Date: May 3, 2012

(54) LED UNIT

(75) Inventor: Hsiu-Ping CHANG, Chu-Nan (TW)

(73) Assignee: FOXSEMICON INTEGRATED TECHNOLOGY, INC., Chu-Nan (TW)

(21) Appl. No.: 13/278,109

(22) Filed: Oct. 20, 2011

(30) Foreign Application Priority Data
Nov. 3, 2010 (TW) 099137737

(51) Int. Cl. F21V 5/04

(52) U.S. Cl. 362/311.02; 362/335

(57) ABSTRACT

A light emitting diode (LED) unit having a lens is disclosed. The lens comprises a base, the base comprising a bottom face configured to a light incident face for light entering the lens, and a top face; a first member and a second member, wherein the first and second members curve outward from the top face of the base, wherein the first member comprises a first light emergent face, the first light emergent face has a convex surface curved outward from the top face, and light emitted from the first light emergent face illuminates areas far away from the lens, and wherein the second member comprises a second light emergent face, the second light emergent face has a rough surface finish, the second light emergent face is at first angle from the top face, and light emitted from the second light emergent face illuminates areas near the lens.

### CROSS-REFERENCE TO RELATED APPLICATION

This patent application is related to two patent applications, having respective Attorney Docket No. “US36820” and “US36863”, both entitled “LED UNIT”, assigned to the same assignee, and disclosures of which are incorporated herein by reference in its entirety.

### BACKGROUND

1. Technical Field

The present disclosure relates to LED (light emitting diode) units, and more particularly, to an LED unit having a lens.

2. Description of Related Art

Light emitting diodes (“LEDs”) are widely used as new types of light sources in various applications such as road lamps, traffic lamps, tunnel lamps, resident lamps and so on. A lens is often used with an LED for collimating the light beams generated from the LED in a predetermined pattern. In LED products designed to illuminate areas at a long distance, a convex lens may be used to converge the light beams emitted from the LED. However, in other applications, such as vehicle headlamps, the LED products need to be able to provide illuminations not only to the area far away from the LED, but also the area near the LED. LED products with the conventional convex lens may not meet such requirements.

What is needed, therefore, is an LED unit which may overcome the deficiencies as described above.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of an LED unit in accordance with an embodiment of the present disclosure.

FIG. 2 is a cross sectional view of the LED unit taken along line II-II of FIG. 1.

### DETAILED DESCRIPTION OF THE EMBODIMENTS

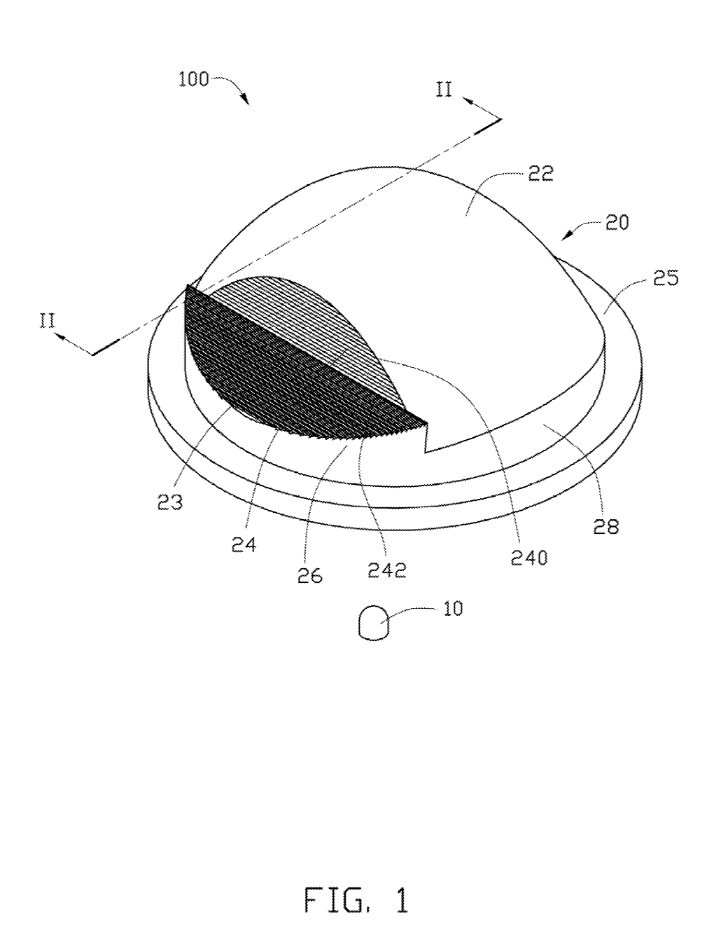

Referring to FIG. 1, an LED unit 100 in accordance with an embodiment of the present disclosure is shown. The LED unit 100 may be applied in vehicle headlamps or other suitable products where both the areas near and remote from the LED unit 100 are required to be illuminated. The LED unit 100 includes a lens 20 on the light emitting side of an LED 10.

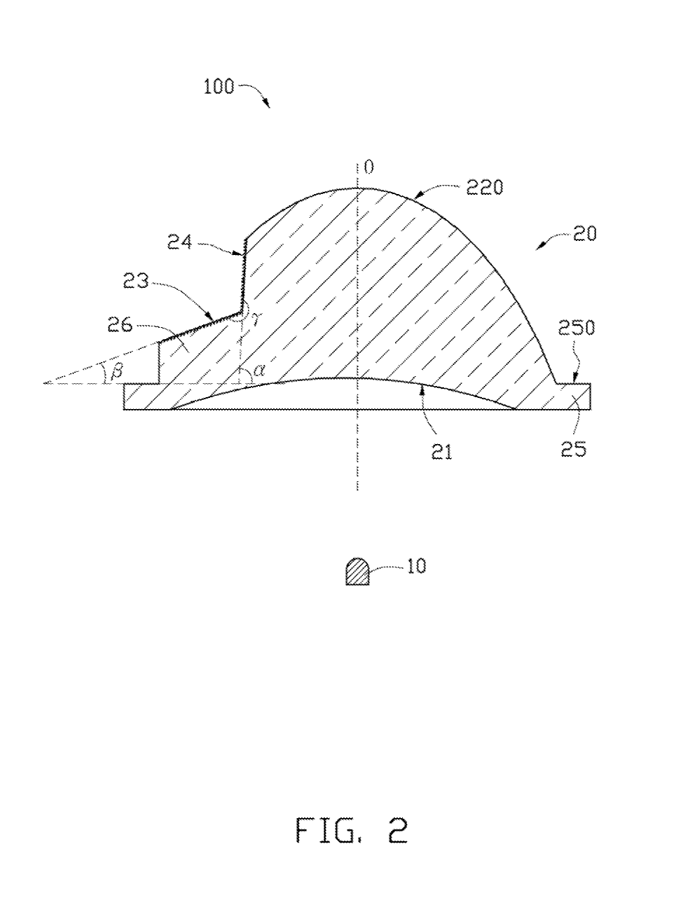

In one embodiment, the LED 10 generates white light. However, other types of LEDs which generate different light colors, may also be used in the LED unit 100. The lens 20 may be made of a transparent material such as epoxy, silicon, glass and so on. Referring to FIG. 2, the lens 20 may include a base 25 and a first member 22 and a second member 26 formed on a top face 250 of the base 25. The base 25 may be a substantially disk shaped. A bottom face of the base 25 may function as a light incident face 21 for transmitting light emitted from the LED 10 to the lens 20. In the embodiment of the present disclosure, the light incident face 21 is a concave surface to diffuse light emitted from the LED 10 into the lens 20. The top face 250 of the base 25 may be planar.

The first member 22 is a convex dome curves outward from the top face 250 of the base 25. Circumferences of the first member 22 have diameters gradually decreasing outward from the top face 250 to a top of the convex doom. The first member 22 may converge a part of incident light from the light incident face 21 into narrow light beams to illuminate areas far away from the LED unit 100. Preferably, the first member 22 has an optical axis O perpendicular to the top face 250 of the base 25. The LED 10 may be placed on the axis O and on the concave side of the lens 20 so that the light emitted by the LED 10 may be collimated by the first member 22 to parallel light beams emitted out of the LED unit 100. An outer face of the first member 22 may function as a first light emergent face 220 for transmitting the light out of the lens 20.

The second member 26 is connected with the first member 22 and has a height less than a height of the first member 22. A continuous annular lateral face 28 comprises a sidewall of the second member 26 and a sidewall of the first member 22. The continuous annular lateral face 28 is connected to the top face 250 of the base 25. The continuous annular lateral face 28 has a largest height where the second member 26 and the first member 22 join. The second member 26 has an inclined top face. The inclined top face of the second member 26 may has a rough surfaced finish which may be formed by a plurality of parallel saws. The inclined top face of the second member 26 may function as a second light emergent face 23 to diffuse and direct the incident light uniformly to illuminate areas near the LED unit 100. The convex doom of the first member 22 is intersected by a third light emergent face 24, which is connected to the second member 26. The third light emergent face 24 has a surface area less than a surface area of the second light emergent face 23, and far less than a surface area of the first light emergent face 220. The third light emergent face 24 is bordered by a curved top edge 240 and a straight bottom edge 242. The third light emergent face 24 is connected to the second light emergent 23 face at the straight bottom edge 242, and connected to the first light emergent face 220 at the curved top edge 240 thereof. The third light emergent face 24 is at an angle α from the top face 250 of the base, wherein the angle α may be equal to or less than 90 degrees. The third light emergent face 24 may also be a rough surface finish face which may be formed by a plurality of parallel saws. The third light emergent face 24, together with the second light emergent face 23, may uniformly diffuse light from the light incident face 21 to provide even better illuminations to areas near the LED unit 100. The second light emergent face 23 of the second member 26 is at an angle β from the top face 250, wherein the angle β is smaller than the angle α. An angle γ between the second light emergent face 23 and the third light emergent face 24, measured facing the LED 10, is between 180 degrees and 270 degrees.

When the LED unit 100 is applied to a headlamp of a vehicle, light emitted from the first light emergent face 220 may form a high beam to illuminate areas far away from the vehicle; whereas light emitted from the second light emergent face 23 and the third light emergent face 24 may form a low beam to illuminate an area near the vehicle. As a result, areas in front of the vehicle may have a better visibility.

It is believed that the present disclosure and its advantages will be understood from the foregoing description, and it will be apparent that various changes may be made thereto without departing from the spirit and scope of the present disclosure or sacrificing all of its material advantages, the examples hereinbefore described merely being preferred or exemplary embodiments.

What is claimed is:

1. A lens comprising:
a base, the base comprising a bottom face configured to a light incident face for light entering the lens, and a top face;
a first member and a second member, wherein the first and second members curve outward from the top face of the base,
wherein the first member comprises a first light emergent face, the first light emergent face has a convex surface curved outward from the top face, and light emitted from the first light emergent face illuminates areas far away from the lens, and
wherein the second member comprises a second light emergent face, the second light emergent face has a rough surface finish, the second light emergent face is at first angle from the top face, and light emitted from the second light emergent face illuminates areas near the lens.

2. The lens of claim 1, wherein the second member has a height less than a height of the first member, measured from the top face.

3. The lens of claim 1, wherein the second member is connected to the first member.

4. The lens of claim 3, wherein a third light emergent face is formed between the second light emergent face and the first light emergent face.

5. The lens of claim 4, wherein the third light emergent face has a curved top edge connected to the first light emergent face, and a straight bottom edge connected to the second light emergent face.

6. The lens of claim 4, wherein the third light emergent face has a rough surface finish.

7. The lens of claim 4, wherein the second light emergent face is at a first angle from the top face, the third light emergent face is at a second angle from the top face, and the second angle is larger than the first angle.

8. The lens of claim 4, wherein the second light emergent face is at a third angle from the third light emergent face, measured facing the bottom face, and the third angle is between 180 degrees and 270 degrees.

9. The lens of claim 1, wherein the first member has an optical axis extending through the light incident face.

10. The lens of claim 5, wherein a continuous annular lateral face comprises a sidewall of the first member and a sidewall of the second member.

11. The lens of claim 10, wherein the continuous annular lateral face has a largest height measured from the top face to the straight bottom edge.

12. The lens of claim 1, wherein surfaces of the second light emergent face and the third light emergent face are saw-toothed.

13. An LED (light emitting diode) unit comprising:
an LED;
a lens comprising a light incident face facing the LED, a second member, and a first member connected to the second member;
wherein the first member comprises a first light emergent face through which light from the LED illuminates areas far away from the lens, the second member comprises a second light emergent face through which light from the LED illuminates areas near the lens; and
a third light emergent face is formed between the first light emergent face and the second light emergent face; wherein the second light emergent face is at an angle from the third light emergent face, measured facing the LED, and the angle is between 180 degrees and 270 degrees.

14. The LED unit of claim 13, wherein the second light emergent face has a saw-toothed surface finish.

15. The LED unit of claim 13, wherein the third light emergent face has a saw-toothed surface, and the third light emergent face is adapted to diffuse light towards areas near the lens.

16. The LED unit of claim 13, wherein the third light emergent face has a curved top edge joined with the first light emergent face, and a straight bottom edge joined with the second light emergent face.

17. The LED unit of claim 13, wherein the second member has a height, measured from the top surface, less than that of the first member.

18. The LED unit of claim 13, wherein the light incident face is a concave face, and the first light emergent face is a convex face.

19. An optical lens comprising:
a light incident face for transmitting light entering the lens; and
a light emitting face for transmitting light out of the lens, wherein the light emitting face comprises a first light emergent face, a second light emergent face, and a third light emergent face interconnecting the first light emergent face and the second light emergent face; wherein the first light emergent face has a convex surface, and the second light emergent face has a rough surface finish.

20. The optical lens of claim 19, wherein the third light emergent face has a rough surface finish, the second light emergent face is inclined relative to an optical axis of the first light emergent face, and an angle between the second and third light emergent faces is larger than 180 degrees and less than 270 degrees.
